(19) United States
(12) Patent Application Publication
(10) Pub. No.: US 2023/0406232 A1
(43) Pub. Date: Dec. 21, 2023

(54) SUBASSEMBLY FOR A MEANS OF TRANSPORT, AND MEANS OF TRANSPORT

(71) Applicant: Continental Automotive Technologies GmbH, Hannover (DE)

(72) Inventor: Marcus Koch, Waldbronn (DE)

(73) Assignee: Continental Automotive Technologies GmbH, Hannover (DE)

(21) Appl. No.: 18/199,454

(22) Filed: May 19, 2023

(30) Foreign Application Priority Data
May 20, 2022 (DE) 10 2022 205 050.9

(51) Int. Cl. B60R 13/02

(52) U.S. Cl. CPC B60R 13/0256; B60K 35/00; B60R 2013/0287; B60R 2013/0293

(57) ABSTRACT

A subassembly for a transport and a transport comprising a subassembly is disclosed. The subassembly has a support element, a component arranged on the support element, and a cover element arranged on the support element, adjoining the component. The support element has a lever mechanism which is configured to raise the cover element above a surface of the component in response to a force acting parallel to a surface of the cover element.

### CROSS REFERENCE TO RELATED APPLICATION

This U.S. patent application claims the benefit of German patent application No. 10 2022 205 050.9, filed May 20, 2022, which is hereby incorporated by reference.

### TECHNICAL FIELD

The present disclosure relates to a subassembly for a means of transport and to a means of transport with such a subassembly.

### BACKGROUND

In modern motor vehicles, display devices are increasingly used to present relevant driving information, to operate equipment of the motor vehicle, or to play media. These display devices are typically arranged in the dashboard.

Display devices for means of transport require protection from the breaking of glass in the case of an accident so that the passengers in the vehicle are not injured by splinters or sharp edges in the case of a head or knee impact. The same also applies for other breakable or splinter-prone components such as, for example, touch-sensitive modules with glass covers. At present, sufficient protection of the passengers in the vehicle from sharp edges and splintering glass is ensured essentially by airbags.

In this connection, WO 2021/242558 A2 describes structural construction solutions for flexible display devices for use in motor vehicle interiors. The display devices comprise a flexible connecting section and are configured such that they meet the requirements of the head impact tests which are usual in the automobile industry.

Current design trends such as wireless design in which neighboring components adjoin one another with almost no gap and form a common surface mean that glass elements can break quickly in the case of an accident. In particular in the case of a side impact, neighboring display devices or cover elements may knock against each other. This is particularly the case when the common surface extends over the whole width of the means of transport. A beveled edge for one of the relevant components generally has little benefit because the thickness of the glass does not provide much scope for a bevel. A beveled edge would additionally cause sharp edges in the case of elements which are this thin.

The object of the disclosure is to provide improved solutions for protection from the breaking of glass in the case of an accident of a means of transport.

### SUMMARY

According to a first aspect of the disclosure, a subassembly for a means of transport has a support element, a component arranged on the support element, and a cover element arranged on the support element, adjoining the component, wherein the support element has a lever mechanism which is configured to raise the cover element above a surface of the component in response to a force acting parallel to a surface of the cover element.

In the solution according to the disclosure, the support element is configured such that, in the case of an accident, a laterally acting force or the sideways movement resulting therefrom causes a movement, perpendicular thereto, of the edge of the cover element relative to the adjoining component. In this way, the unbreakable edge of the cover element is shifted above and preferably also in front of a sensitive glass edge of the adjoining component such that the two edges do not knock against each other. In this way, the risk of glass breaking is reduced and the passengers are thus better protected from splinters. If the cover element overlaps the glass edge of the component, in the case of glass breaking it itself blocks the direct path of possible splinters into the vehicle interior. For example, the component may be a display device or another breakable or splinter-prone component.

According to one aspect of the disclosure, the support element has a deformation area. Such a deformation area has the advantage that energy from the accident is absorbed by the deformation and the movement of the cover element is decelerated.

According to one aspect of the disclosure, the cover element is beveled on its underside toward the edge in an area adjoining the component. Such a bevel enables the cover element to slide on the component as soon as the edge area of the cover element rises only slightly above the surface of the component.

According to one aspect of the disclosure, the lever mechanism has a long lever arm area, a short lever arm area, and a linkage area. Because a relatively large lifting movement of the cover element has to be obtained as soon as there is a small sideways movement, long lever arm areas of different lengths are used. The linkage area serves to trigger rotation of the two lever arm areas. In this case, a possible deformation area is for example configured such that the deformation begins only when the long lever arm area has raised the cover element far enough that it can slide over the surface of the component without colliding with the component.

According to one aspect of the disclosure, the short lever arm area and the linkage area are connected by a connecting area. The connecting area is configured such that it can deform more easily than the short lever arm area and the linkage area such that the two areas are partially uncoupled. For this purpose, the thickness of the connecting area can, for example, be smaller than the thickness of the linkage area and the thickness of the short lever arm area. When the cover element is raised by the lever mechanism, the angle of the short lever arm area changes relative to the force that is acting, this being compensated by the connecting area. Additionally, the connecting area can be configured as an intended breaking point at which, as the force continues to act, a break occurs when the cover element has been raised sufficiently.

According to one aspect of the disclosure, the support element is configured as a single piece. The one-piece embodiment has the advantage that cost-effective production of the support element is enabled. In particular, there is no need to mount individual elements of the support element. The one-piece embodiment may be achieved, for example, by shaping the support element in a suitable manner. This also enables the use of magnesium-based materials for the support element. Magnesium is particularly light but nevertheless stable enough to be able to support in particular also a large-area component. Other materials for the support element can of course also be used.

According to one aspect of the disclosure, the lever mechanism is formed by cutouts of the support element. The lever mechanism may be implemented without the need for additional elements being mounted on the support element. In this way, the production costs for the subassembly may be further reduced.

According to one aspect of the disclosure, the support element has two or more lever mechanisms. For example, a second lever mechanism may be used to move a side of the cover element which faces away from the component below the plane of the surface of the component. In this way, the same angle of inclination of the cover element relative to the component is obtained for a function distributed over a plurality of lever mechanisms. This is in particular advantageous in the case of confined space conditions.

According to one aspect of the disclosure, the surface of the cover element and the surface of the component merge essentially seamlessly into each other. Essentially seamlessly is understood to mean here that there is no step between the two surfaces and that any curvature of the surfaces also is uniform. However, a small narrow gap can be situated between the surfaces. Such a gap preferably has a width of no more than 0.5 mm. The essentially seamless transition enables the subassembly to be used as part of a seamless design.

A subassembly according to the disclosure is preferably used in a means of transport, for example in the form of a dashboard. The means of transport may be, for example, a motor vehicle but alternatively also an aircraft, a rail vehicle, or a water vehicle.

Further features of the present disclosure will emerge from the following description and the appended claims in conjunction with the figures.

### BRIEF DESCRIPTION OF THE DRAWINGS

FIG. 1 schematically shows a dashboard for a motor vehicle;

FIG. 2 illustrates damage to a display device installed in a conventional subassembly;

FIG. 3 illustrates the avoidance of damage to a display device installed in a subassembly according to the disclosure;

FIG. 4 schematically shows a simple lever mechanism for a subassembly according to the disclosure;

FIG. 5 schematically shows a support element with a lever mechanism;

FIG. 6 schematically shows a first embodiment of a support element with two lever mechanisms;

FIG. 7 schematically shows a second embodiment of a support element with two lever mechanisms;

FIG. 8 schematically shows a plan view of a support element with a plurality of lever mechanisms; and

FIG. 9 schematically shows a means of transport which uses a subassembly according to the disclosure.

### DETAILED DESCRIPTION

For a better understanding of the principles of the present disclosure, embodiments of the disclosure will be explained in more detail below with reference to the figures. The same reference signs are used in the figures for identical or functionally identical elements and are not necessarily described again for each figure. It goes without saying that the disclosure is not limited to the illustrated embodiments and that the described features may also be combined or modified without departing from the scope of protection of the disclosure as defined in the appended claims.

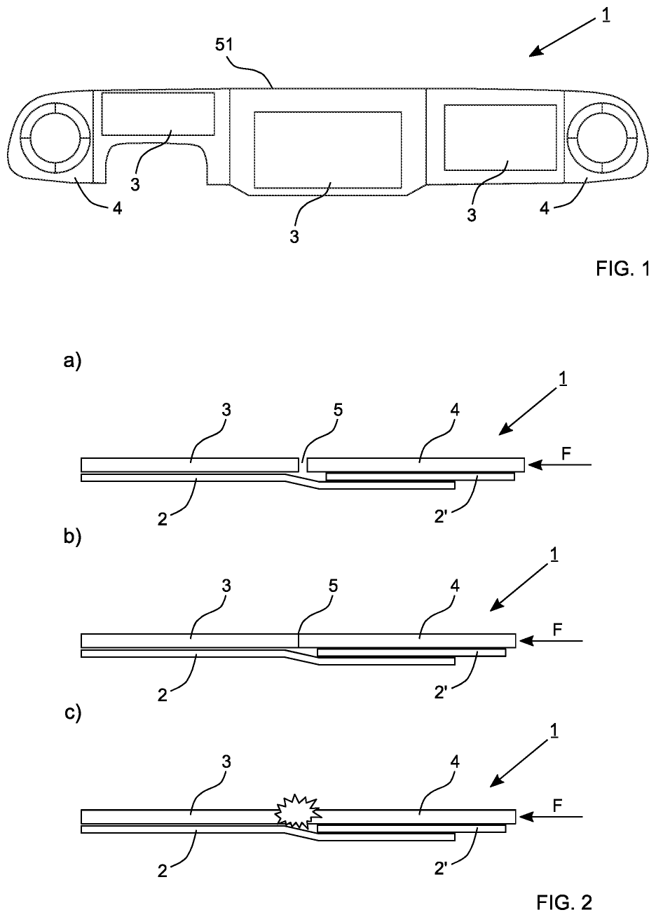

FIG. 1 schematically shows a dashboard 51 for a motor vehicle as an example of a subassembly 1. The dashboard 51 is designed such that it extends over the whole width of the motor vehicle. It has a plurality of display devices 3 and cover elements 4 adjoining them. The cover elements 4 serve in this example at the same time as covers for ventilation nozzles. The display devices 3 and the cover elements 4 are arranged such that they adjoin one another with almost no gaps and form a common surface. In the case of an accident, in particular a side impact, this can quickly cause the display devices 3 and the cover elements 4 to knock against one another such that it is possible that glass elements can break. The splinters and sharp edges which are thus created represent a risk of injury for the passengers of the vehicle. The same also applies for other breakable or splinter-prone components such as, for example, touch-sensitive modules with glass covers.

FIG. 2 illustrates damage to a display device 3 installed in a conventional subassembly 1. The display device 3 is arranged on a support element 2, 2′. A cover element 4 is arranged on the support element 2, 2′, adjoining the display device 3. In this example, the support element 2, 2′ is formed from two individual elements. A gap 5 with a width of generally no more than 1 mm, preferably less than 0.5 mm, is situated between the display device 3 and the cover element 4. Following a side impact, an essentially laterally acting force F is exerted on the cover element 4. This is illustrated in FIG. 2a). The force F causes the cover element 4 to be displaced in the direction of the display device 3 until the cover element 4 finally knocks against the display device 3. This situation is illustrated in FIG. 2b). Following the continued lateral exertion of force, the display device 3 finally breaks, upon which splinters of glass and sharp edges can be created. This is illustrated in FIG. 2c).

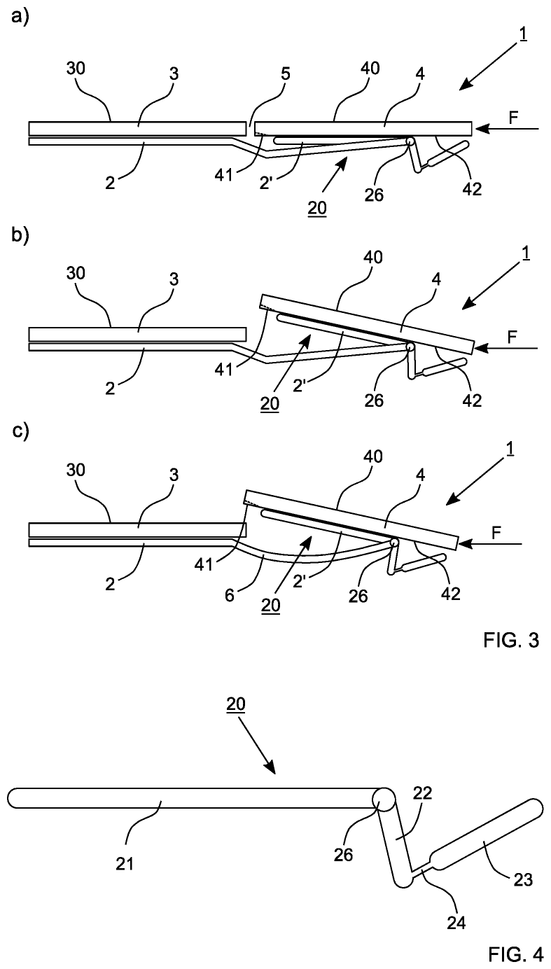

FIG. 3 illustrates the avoidance of damage to a display device 3 installed in a subassembly 1 according to the disclosure. The display device 3 is arranged on a support element 2, 2′. A cover element 4 is arranged on the support element 2, 2′, adjoining the display device 3. A gap 5 with a width of less than 1 mm, for example less than 0.5 mm, is situated between the display device 3 and the cover element 4. Following a side impact, an essentially laterally acting force F is exerted on the cover element 4. This is illustrated in FIG. 3a). The support element 2, 2′ now, however, has one lever mechanism 20. This is configured to raise the cover element 4 above a surface 30 of the display device 3 in response to a force acting parallel to a surface 40 of the cover element 4. As may be seen in FIG. 3b), the force F initially causes the cover element 4 to rotate about an axis of rotation 26. The cover element 4 is here raised far enough that, as the exertion of force progresses, it may be shifted above the display device 3, i.e. lateral knocking of the cover element 4 against the display device 3 is avoided. Following a continued lateral exertion of force, lastly deformation of the support element 2, 2′ in a deformation area 6 occurs. This is illustrated in FIG. 3c). Should breakage of the display device 3 indeed now occur, the cover element 4 blocks the direct path of possible splinters into the vehicle interior. As indicated in FIG. 3, the cover element 4 may be beveled on its underside 42 toward the edge in an area 41 adjoining the display device 3. This enables the cover element 4 to slide on the display device 3 as soon as the edge area 41 of the cover element 4 rises only slightly above the surface 30 of the display device 3.

FIG. 4 schematically shows a simple lever mechanism 20 for a subassembly according to the disclosure. The lever mechanism 20 has a long lever arm area 21, a short lever arm area 22, and a linkage area 23. The thickness of the cover element is of the order of approximately 2 mm, whereas the gap between the cover element and the display device has a width of preferably less than 0.5 mm. Therefore a relatively great rising movement of the cover element must be obtained as soon as there is a small sideways movement of the cover element. For this purpose, lever arm areas 21, 22 of different lengths are used which are arranged at an angle to each other, for example at an angle between 70° and 90°. The linkage area 23 serves to trigger rotation of the two lever arm areas 21, 22 about an axis of rotation 26. In the example shown, the short lever arm area 22 and the linkage area 23 are connected by a connecting area 24. The connecting area 24 is configured such that it can deform more easily than the short lever arm area 22 and the linkage area 23. This ensures that the two areas 22, 23 are partially uncoupled. The uncoupling may be achieved, for example, by the thickness of the connecting area 24 being smaller than the thickness of the linkage area 23 and the thickness of the short lever arm area 22. Furthermore, the connecting area 24 may be configured as an intended breaking point at which, as the force continues to act, a break occurs when the cover element has been raised sufficiently.

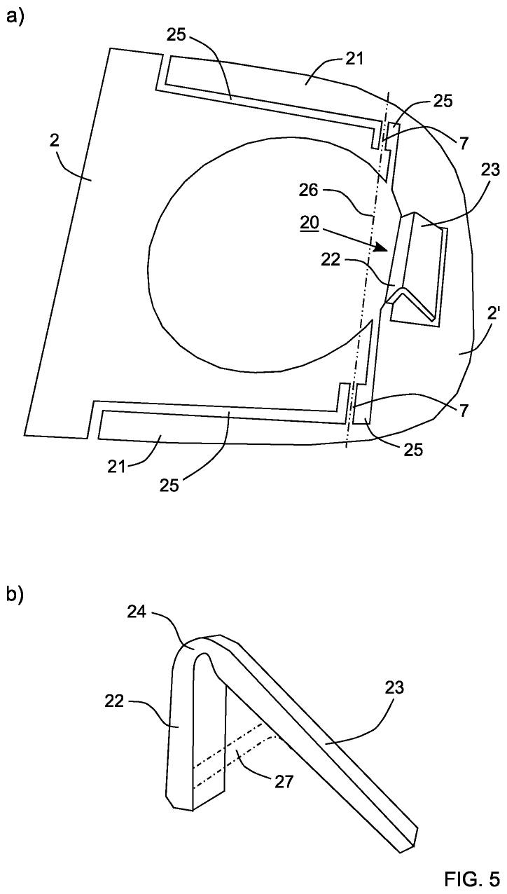

FIG. 5 schematically shows a support element 2, 2′ with a lever mechanism A plan view of the support element 2, 2′ is illustrated here in FIG. 5a). The support element 2, 2′ consists of two elements which are connected to each other by means of two webs 7. The webs 7 are shaped by cutouts 25 of the support element 2, 2′ and define an axis of rotation 26 for the lever mechanism 20. A short lever arm area 22 and a linkage area 23 are integrally formed on the support element 2, 2′. A part of the support element 2, 2′ serves as a long lever arm area 21. During mounting, the cover element is fastened only on the movable second element 2′ of the support element 2, 2′ such that it may be raised relative to the rigid first element 2 of the support element 2, 2′. FIG. 5b) shows a detailed view of the short lever arm area 22 and the linkage area 23. The two areas 22, 23 are connected by a connecting area 24 of reduced thickness which partially uncouples the short lever arm area 22 and the linkage area 23. However, additional reinforcement 27 may be provided when required.

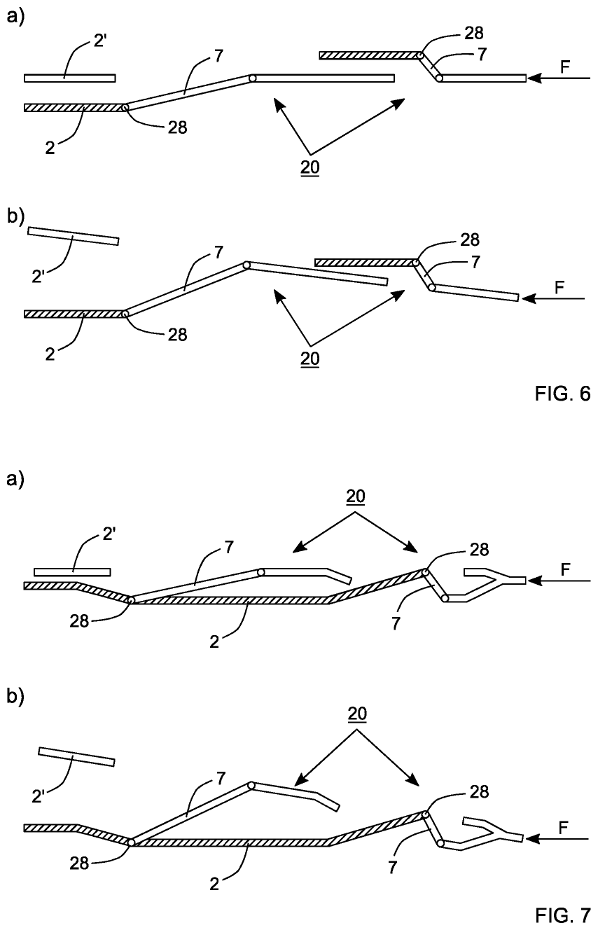

FIG. 6 schematically shows a first exemplary embodiment of a support element 2, 2′ with two lever mechanisms 20. In this embodiment, the support element 2, 2′ also consists of two elements connected to each other, i.e. a rigid first element 2 and a second element 2′ which is movable relative thereto. The two elements of the support element 2, 2′ are connected movably to each other by webs 7 which are fixed to fixing points 28 of the first element 2 of the support element 2, 2′ and are a constituent part of the lever mechanisms 20. During mounting, the cover element is fastened only on the movable second element 2′ of the support element 2, 2′ such that it may be raised relative to the rigid first element 2 of the support element 2, 2′. FIG. 6a) shows the situation in which a force F acting laterally begins to be exerted. By virtue of the exertion of the force, rotation of the movable second element 2′ relative to the rigid first element 2 of the support element 2, 2′ is caused. This rotation is illustrated in FIG. 6b).

FIG. 7 schematically shows a second exemplary embodiment of a support element 2, 2′ with two lever mechanisms 20. In this embodiment, the support element 2, 2′ also consists of two elements connected to each other, i.e. a rigid first element 2 and a second element 2′ which is movable relative thereto. The two elements of the support element 2, 2′ are connected movably to each other by webs 7 which are fixed to fixing points 28 of the first element 2 of the support element 2, 2′ and are a constituent part of the lever mechanisms 20. During mounting, the cover element is fastened only on the movable second element 2′ of the support element 2, 2′ such that it may be raised relative to the rigid first element 2 of the support element 2, 2′. FIG. 7a) shows the situation in which a force F acting laterally begins to be exerted. By virtue of the exertion of the force, rotation of the movable second element 2′ relative to the rigid first element 2 of the support element 2, 2′ is caused. This rotation is illustrated in FIG. 7b).

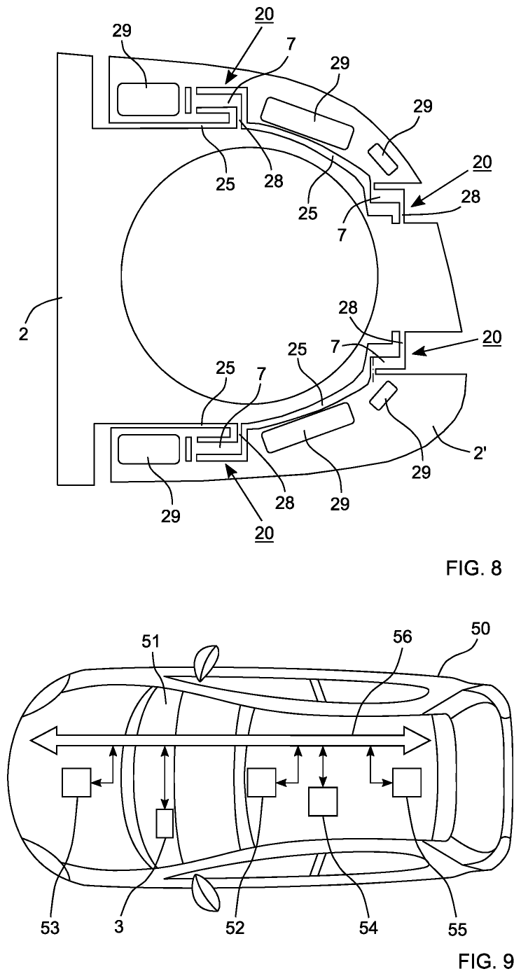

FIG. 8 schematically shows a plan view of a support element 2, 2′ with a plurality of lever mechanisms 20. The support element 2, 2′ consists of two elements which are connected to each other by means of a plurality of webs 7. The webs 7 are shaped by cutouts 25 of the support element 2, 2′ which are fixed to fixing points 28 of the first element 2 of the support element 2, 2′ and are a constituent part of the lever mechanisms 20. During mounting, the cover element is fastened only on the movable second element 2′ of the support element 2, 2′ such that it may be raised relative to the rigid first element 2 of the support element 2, 2′. For this purpose, the movable second element 2′ has a number of adhesive areas 29.

FIG. 9 schematically shows a means of transport 50 which uses a subassembly according to the disclosure. In this example, the means of transport is a motor vehicle and the subassembly is the dashboard 51. The motor vehicle has a display device 3 which is arranged in the dashboard 51. Data on the vehicle surroundings may be acquired by a sensor system 52. The sensor system 52 may in particular comprise surroundings recognition sensors, for example ultrasound sensors, laser scanners, radar sensors, lidar sensors, or cameras. The information acquired by the sensor system 52 may be used to generate content to be displayed for the display device 3. Further constituent parts of the motor vehicle in this example are a navigation system 53, by which positional information may be provided, and also a data transmission unit 54. A connection to a back-end, for example for receiving updated software for the components of the motor vehicle, may, for example, be established by means of the data transmission unit 54. A memory 55 is present for storing data. Data is exchanged between the various components of the motor vehicle via a network 56.

1. A subassembly for a transport, comprising:
a support element;
a component arranged on the support element; and
a cover element arranged on the support element, adjoining the component, wherein the support element has a lever mechanism which is configured to raise the cover element above a surface of the component in response to a force acting parallel to a surface of the cover element.

2. The subassembly as claimed in claim 1, wherein the support element has a deformation area.

3. The subassembly as claimed in claim 1, wherein the cover element is beveled on its underside toward the edge in an area adjoining the component.

4. The subassembly as claimed in claim 1, wherein the lever mechanism has a long lever arm area, a short lever arm area, and a linkage area.

5. The subassembly as claimed in claim 4, wherein the short lever arm area and the linkage area are connected by a connecting area.

6. The subassembly as claimed in claim 1, wherein the support element is configured as a single piece.

7. The subassembly as claimed in claim 6, wherein the lever mechanism is formed by cutouts of the support element.

8. The subassembly as claimed in claim 1, wherein the support element has two or more lever mechanisms.

9. The subassembly as claimed in claim 1, wherein the surface of the cover element and the surface of the component merge essentially seamlessly into each other.

10. A transport, comprising:
a subassembly, comprising:
a support element;
a component arranged on the support element; and
a cover element arranged on the support element, adjoining the component, wherein the support element has a lever mechanism which is configured to raise the cover element above a surface of the component in response to a force acting parallel to a surface of the cover element.
